(19) United States
(12) Patent Application Publication
(10) Pub. No.: US 2013/0206488 A1
(43) Pub. Date: Aug. 15, 2013

(54) LEGGED ROBOT

(71) Applicant: Panasonic Corporation, (US)

(72) Inventor: Takashi HORINOUCHI, Osaka (JP)

(73) Assignee: PANASONIC CORPORATION, Osaka (JP)

(21) Appl. No.: 13/800,584

(22) Filed: Mar. 13, 2013

Related U.S. Application Data
(63) Continuation of application No. PCT/JP2012/003886, filed on Jun. 14, 2012.

(30) Foreign Application Priority Data
Feb. 13, 2012 (JP) 2012-028156

(51) Int. Cl. A63H 11/20; B62D 57/032

(52) U.S. Cl. CPC A63H 11/20; B62D 57/032; Y10S 901/01
USPC 180/8.6; 901/1

(57) ABSTRACT

The legged robot includes a trunk and a leg connected to the trunk. The trunk includes: a first link and a second link connected with each other via a first revolute joint that is rotatable about a roll axis; a third link connected with the first link via a second revolute joint rotatable about a yaw axis; and a fourth link connected with the second link via a third revolute joint rotatable about a yaw axis. The leg is connected to at least one of the third link and the fourth link.

### CROSS REFERENCE TO RELATED APPLICATIONS

This is a continuation application of PCT International Application No. PCT/JP2012/003886 filed on Jun. 14, 2012, designating the United States of America, which is based on and claims priority of Japanese Patent Application No. 2012-028156 filed on Feb. 13, 2012. The entire disclosures of the above-identified applications, including the specifications, drawings and claims are incorporated herein by reference in their entirety.

### FIELD

The present disclosure relates to a legged robot which shows emotional expression, using a mechanism for a head, a leg, and a trunk which are movable.

### BACKGROUND

In recent years, robots for family use have been sold by domestic and international manufacturers, and there are increasing opportunities to see such robots in ordinary households. Among these robots, communication robots for daily living, which respond to calls from people, are beginning to be implemented. The communication robots look like humans or pets such as a dog with relatively high intelligence. Most of them show emotional feelings throughout their bodies each having a head, arms, and legs (See Patent Literature 1, for example).

### CITATION LIST

### Patent Literature

[PTL 1] Japanese Unexamined Patent Application Publication No. 2003-71763
[PTL 2] Japanese Unexamined Patent Application Publication No. 2010-5718

### SUMMARY

### Technical Problem

In order to make such a communication robot highly expressive in emotions, the communication robot could have a complex axis system which has as many spine joints (24) as those of a mammal. However, it is difficult to implement a communication robot having such an axis system in terms of downsizing and improving mechanical rigidity of the robot. Moreover, a structure with many joints is unrealistic in reducing the production cost the robot.

The present disclosure is conceived in view of the above problems, and provides a robot which is built in a simple structure and shows highly expressive emotions.

### Solution to Problem

A legged robot according to an aspect of the present disclosure includes a trunk and a leg connected to the trunk. The trunk includes: a first link and a second link which are connected with each other via a first revolute joint that is rotatable about a roll axis; a third link which is connected with the first link via a second revolute joint that is rotatable about a yaw axis; and a fourth link which is connected with the second link via a third revolute joint that is rotatable about a yaw axis, and the leg is connected to at least one of the third link and the fourth link.

### Advantageous Effects

The present disclosure can implement a legged robot which is built in a simple structure and shows highly expressive emotions.

### BRIEF DESCRIPTION OF DRAWINGS

These and other aims, advantages and features of the disclosure will become apparent from the following description thereof taken in conjunction with the accompanying drawings that illustrate a specific embodiment of the present disclosure.

FIG. 1 shows an external view of a legged robot according to an embodiment of the present disclosure.

FIG. 2 shows a principle of a joint mechanism of a trunk.

FIG. 3 depicts a perspective view showing an exemplary joint mechanism of the trunk.

FIG. 4 depicts a block diagram showing a functional structure of the legged robot.

FIG. 5 depicts a perspective view showing an exemplary mechanism of a leg.

FIG. 6 shows how the legged robot exhibits the motions of sitting with its legs out to one side and leaning on a person's leg to express emotional feelings of “sense of ease” and “dependence”.

FIG. 7 shows how the legged robot exhibits the motion of lying on its back to express an emotional feeling of “obedience”.

FIG. 8 shows how the legged robot exhibits the motion of rubbing its back on the floor to express an emotional feeling of “elevated mood”.

FIG. 9 shows how the legged robot exhibits the motion of deeply bending itself as if chasing after its tail to express emotional feelings of “anxiety” and “stress”.

FIG. 10 depicts a perspective view showing another exemplary joint mechanism of the trunk.

### DESCRIPTION OF EMBODIMENT

### Insight as Basis of Disclosure

There have been various techniques proposed to implement robotic joints.

For example, Patent literature 1 proposes a four-legged robot which can walk with movable legs attached to the trunk and having hip joints and knee joints. The robot can express emotional feelings by exhibiting several motions such as sitting and lying down with a combination of the motions of a movable head and opening and closing legs.

Patent literature 2 proposes another exemplary robot having any one of a roll axis, a pitch axis, and a yaw axis added to a part of the trunk. Such an axis system is an idea to increase a range of motion required to walk over bumps without upsizing the robot itself.

The expressions of emotional feelings, by the exhibition of motions close to those of an animal, are required of a legged robot designed to make a user feel comfortable and establish two-way communications with the user. In particular, such expressions are required of an animal-type robot.

Specifically, as typical exhibitions of motions associated with expressions of a dog's emotional feelings which show “sense of ease” and “dependence”, the dog sits with its legs out to one side and leans on a person's leg and a wall. Moreover, the dog exhibits the motions of: lying on the back to express an emotional feeling of “obedience”; rubbing its back on the floor to express an emotional feeling of “elevated mood”; and walking with its trunk deeply bent and as if chasing after its tail to express emotional feelings of “anxiety” and “stress”.

Meanwhile, the legged robot, which is capable of expressing emotional feelings as described above and having an axis system including as many spine joints (24) as those of a mammal, is complex structure-wise and control-wise, which makes it difficult to implement such a robot. Another difficulty in such a legged robot having many joints is that the implementation of the robot is unrealistic in reducing its production cost.

In order to solve the above problems, a legged robot according to an aspect of the present disclosure includes a trunk and a leg connected to the trunk. The trunk includes: a first link and a second link which are connected with each other via a first revolute joint that is rotatable about a roll axis; a third link which is connected with the first link via a second revolute joint that is rotatable about a yaw axis; and a fourth link which is connected with the second link via a third revolute joint that is rotatable about a yaw axis, and the leg is connected to at least one of the third link and the fourth link.

Along with the trunk having the third link and the fourth link, for example, a thorax is provided to the third link and a waist is provided to the fourth link. Specifically, with respect to the waist, the thorax makes twofold free rotation: the free rotation by the second revolute joint about the yaw axis, and the free rotation by the first revolute joint about the roll axis. Similarly, with respect to the thorax, the waist makes twofold free rotation: the free rotation by the third revolute joint about the yaw axis, and the free rotation by the first revolute joint about the roll axis. Hence, the legged robot can take advantage of such free rotations, and take various postures to express emotional feelings.

The first link and the second link do not have to include therein any movable parts.

The legged robot may further include: a left front leg and a right front leg which are included in the leg that is connected to the third link; and a left back leg and a right back leg which are included in the leg that is connected to the fourth link, wherein the legged robot may walk on a walking surface using the left front leg, the right front leg, the left back leg, and the right back leg.

The legged robot may further include a control unit which controls driving of the first revolute joint, the second revolute joint, and the third revolute joint to drive.

When the legged robot is standing on the walking surface, the control unit may cause the legged robot to sit with the left back leg and the right back leg out to one side, by driving the first revolute joint to move the second link with respect to the first link, and laying the left back leg and the right back leg on the walking surface. When the legged robot is sitting with the left back leg and the right back leg out to one side, an orientation of the third link about the yaw axis may be variable through the drive of the second revolute joint, and a distance between the walking surface and the fourth link may be variable through the drive of the third revolute joint.

In other words, the legged robot can take a posture of sitting with its legs out to one side.

When the legged robot is laying the left back leg and the right back leg on the walking surface, and sitting with the left back leg and the right back leg out to one side, the control unit may cause the legged robot to lie on one side the trunk laid on the walking surface, by (i) driving the first revolute joint to move the first link with respect to the second link, and (ii) laying the left front leg and the right front leg in a same direction in which the left back leg and the right back leg are laid.

In other words, the legged robot can take a posture of lying on its side.

When the legged robot is lying on one side with the trunk laid on the walking surface, the control unit may cause the legged robot to lie back and show that a top of the trunk, seen when the legged robot stands on the walking surface, touches on the walking surface by one of: (i) an inertial force generated by driving the first revolute joint to move the laid left front leg and the laid right front leg away from the walking surface; and (ii) an inertial force generated by driving the first revolute joint to move the laid left back leg and the laid right back leg away from the walking surface.

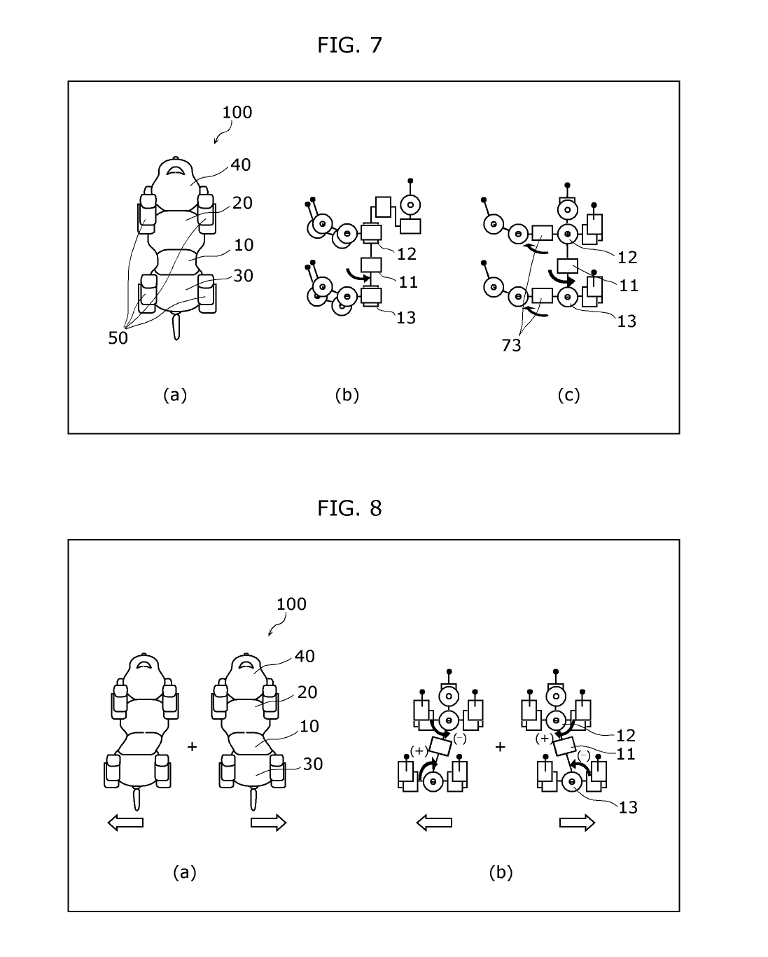

In other words, the legged robot can take a posture of lying on the back as shown in FIG. 7.

When the legged robot is lying back and showing that a top of the trunk, seen when the legged robot stands on the walking surface, touches the walking surface, and when, seen from a direction perpendicular to the walking surface, a normal direction is (i) a rotation direction of the second revolute joint in which the third link rotates clockwise with respect to the first link, and (ii) a rotation direction of the third revolute joint in which the second link rotates clockwise with respect to the fourth link, the control unit may: drive the second revolute joint to alternately rotate in the normal direction and a direction which is opposite the normal direction; and drive the third revolute joint to rotate in conjunction with the second revolute joint, so that the second revolute joint and the third revolute joint rotate at a same rotation speed in opposite directions.

In other words, the legged robot can exhibit a motion of rubbing its back on the floor to express an emotional feeling of “elevated mood” as shown in FIG. 8.

When the legged robot stands on the walking surface, and when, seen from a direction perpendicular to the walking surface, a normal direction is (i) a rotation direction of the second revolute joint in which the third link rotates clockwise with respect to the first link, and (ii) a rotation direction of the third revolute joint in which the second link rotates clockwise with respect to the fourth link, the control unit may cause the legged robot to walk with both the second revolute joint and the third revolute joint driven in one of the normal direction and a direction which is opposite the normal direction.

In other words, the legged robot can exhibit a motion of deeply bending itself as if chasing after its tail to express emotional feelings of “anxiety” and “stress”.

The control unit is may cause driving units to drive the first revolute joint, the second revolute joint, and the third revolute joint, the driving units each being provided to a corresponding one of the first revolute joint, the second revolute joint, and the third revolute joint, one of the driving units for driving the second revolute joint may be provided to the third link, and one of the driving units for driving the third revolute joint may be provided to the fourth link.

The control unit may cause driving units to drive the first revolute joint, the second revolute joint, and the third revolute joint, the driving units each being provided to a corresponding one of the first revolute joint, the second revolute joint, and the third revolute joint, one of the driving units for driving the second revolute joint is provided to the first link, and one of the driving units for driving the third revolute joint is provided to the second link.

### Embodiment

Described hereinafter is a legged robot according to an embodiment of the present disclosure.

It is noted that the embodiments below are specific examples of the present disclosure. The numerical values, shapes, materials, constitutional elements, arrangement positions and connecting schemes of the constitutional elements, steps, and an order of steps all described in the embodiments are examples, and shall not be defined as they are. Hence, among the constitutional elements in the embodiment, those not described in an independent claim representing the most generic concept of the present disclosure are described as given constitutional elements.

As an exemplary legged robot, the embodiment describes an animal-type robot which looks like a dog, with reference to the drawings.

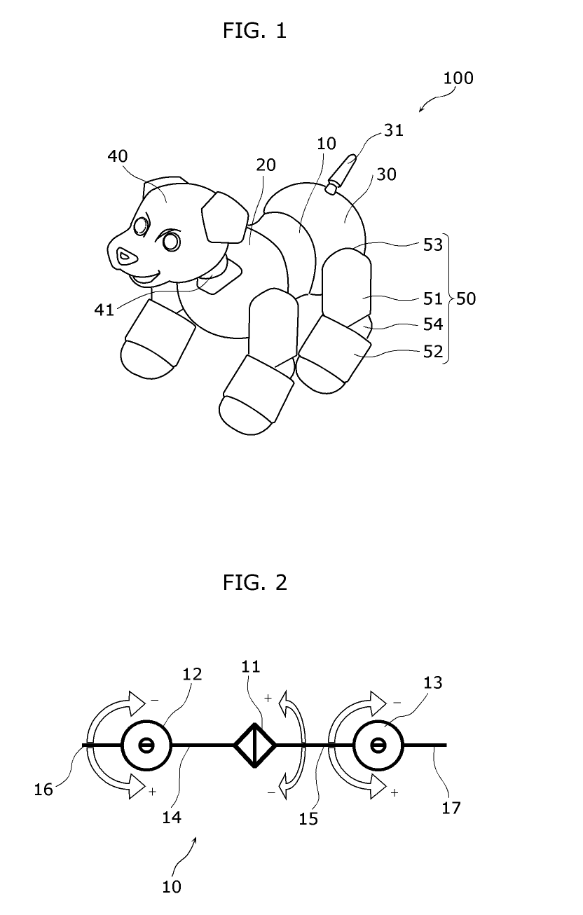

FIG. 1 depicts an external view showing a structure of an animal-type legged robot which looks like a dog.

Unless otherwise noted, the directions in the embodiment are defined based on the case where the legged robot stands on the walking surface (floor surface) with its legs. For example, the front is in a direction in which the legged robot walks. In other words, the head of the legged robot is in the front. In contrast, the tail of the legged robot is in the back.

Similarly, the top is in a direction against the gravity with respect to the walking surface, and the bottom is a direction for the gravity with respect to the walking surface. The left and the right are the left and right with respect to the direction in which the legged robot walks.

Similarly, the roll axis, the pitch axis, and the yaw axis are the axes of a reference posture in which the legged robot stands on the walking surface with its legs. In other words, the roll axis defines the direction in which the legged robot walks, and the yaw axis defines the direction vertical to the walking surface on which the legged robot walks.

As shown in FIG. 1, a legged robot 100 in an animal form includes: a trunk 10; a thorax 20 provided in front of the trunk 10; a waist 30 provided in back of the trunk 10 and having a tail 31; a head 40 attached to the top of the thorax; and four legs 50: one attached to the left of the thorax 20, one attached to the right of the thorax 20, one attached to the left of the waist 30, and one attached to the right of the waist 30.

The head 40 is attached to the front of the thorax 20 on the top via a neck joint 41 which freely rotates about the roll axis, the pitch axis, and the yaw axis.

Moreover, the thorax 20 and the waist 30 are respectively provided in front and back of the trunk 10.

Each of the legs 50 includes a hip joint 53, a thigh 51, a knee joint 54, and a shank 52.

Through a corresponding one of the hip joints 53 that freely rotates about the roll axis and the pitch axis, one thigh 51 is attached to the left end of the thorax 20, one thigh 51 is attached to the right end of the thorax 20, one thigh 51 is attached to the left end of the waist 30, and one thigh 51 is attached to the right end of the waist 30. The thigh 51 and the shank 52 are connected with each other via the knee joint 54 which can freely rotate about the pitch axis.

The legged robot 100 has the four legs 50: one attached to the left of the thorax 20, one attached to the right of the thorax 20, one attached to the left of the waist 30, and one attached to the right of the waist 30. Using the legs 50, the legged robot 100 can support its trunk 10 to take a posture of “stand”.

It is noted that the head 40 includes a control unit (control circuit) which causes an actuator (driving unit) to control the overall motion of the legged robot 100. Here the actuator is provided to each revolute joint of the legged robot 100, and includes a motor and a gear mechanism. The waist 30 includes a battery for supplying power to the legged robot 100.

Described next is the axis system; that is the trunk mechanism, of the trunk 10.

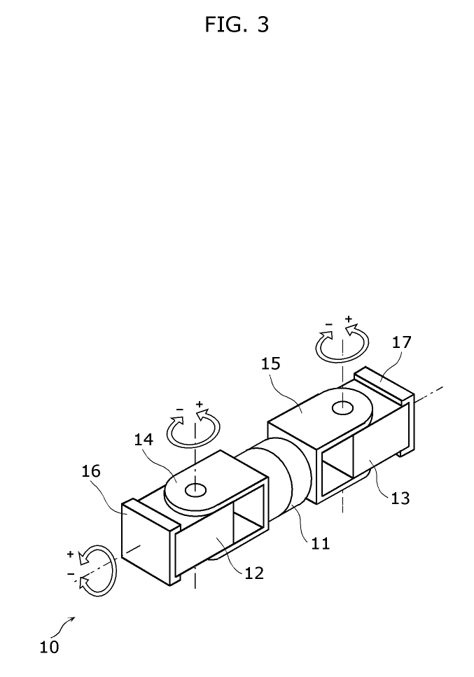

FIG. 2 shows a principle of the axis system of the trunk 10 of the legged robot 100 according to an implementation of the present disclosure.

FIG. 2 shows the trunk 10 viewed from straight above (upperpart) the legged robot. In FIG. 2, the head 40 is on the left, and + (plus) and − (minus) with arrows respectively indicate the normal rotation direction and the reverse rotation direction.

As shown in FIG. 2, the trunk 10 includes: a first revolute joint 11 which freely rotates about the roll axis; and a second revolute joint 12 and a third revolute joint 13 each of which is mechanically attached to either end of the first revolute joint 11, and freely rotates about the yaw axis. The first revolute joint 11 and the second revolute joint 12 are connected with each other via an internal link 14 (first link). The first revolute joint 11 and the third revolute joint 13 are connected with each other via an internal link 15 (second link).

Moreover, an external link 16 (third link) is connected to an end of the trunk 10; that is the end of the second revolute joint 12 where the internal link 14 is not connected. Similarly, an external link 17 (fourth link) is connected to another end of the trunk 10; that is, the end of the third revolute joint 13 where the internal link 15 is not connected.

In FIG. 3, the links are described as members; however, the links are not always members. In the case where joint members are directly connected with each other, for example, the links are the joint areas of the joint members. Furthermore, in the case where the joint members are connected with each other via the motor shafts of the joint members, the links are the motor shafts.

Hence, the trunk 10 makes threefold free rotation: the free rotation by the second revolute joint 12 about the yaw axis, the free rotation by the first revolute joint 11 about the roll axis, and the free rotation by the third revolute joint 13 about the yaw axis.

FIG. 3 depicts a perspective view showing an exemplary joint mechanism of the trunk 10 based on the principle illustrated in FIG. 2. It is noted that FIG. 2 illustrating the principle and FIG. 3 share the same numerical signs for corresponding parts to each other. In FIG. 3, the head 40 is on the left (front) of the legged robot 100.

As shown in FIG. 3, the internal link 14 is connected to one end of the first revolute joint 11, and the internal link 15 is connected to the other end of the first revolute joint 11. In other words, the internal link 14 and the internal link 15 are connected with each other via the first revolute joint 11.

Hence, the internal link 14 can rotate about the roll axis with respect to the internal link 15. In other words, the internal link 15 can rotate about the roll axis with respect to the internal link 14. Specifically, the relative rotation angle between the internal link 14 and the internal link 15 about the roll axis is variable.

One end of the internal link 14, which is not connected with the first revolute joint 11, is connected with the second revolute joint 12. Moreover, the external link 16 is connected to the second revolute joint 12. In other words, the internal link 14 and the external link 16 are connected with each other via the second revolute joint 12.

Hence, the internal link 14 can rotate about the roll axis with respect to the external link 16. In other words, the external link 16 can rotate about the roll axis with respect to the internal link 14. Specifically, the relative angle between the internal link 14 and the internal link 15 about the roll axis is variable.

Meanwhile, an end of the internal link 15, which is not connected with the first revolute joint 11, is connected with the third revolute joint 13. Moreover, the external link 17 is connected to the third revolute joint 13. In other words, the internal link 15 and the external link 17 are connected with each other via the third revolute joint 13.

Hence, the internal link 15 can rotate about the roll axis with respect to the external link 17. In other words, the external link 17 can rotate about the roll axis with respect to the internal link 15. Specifically, the relative angle between the internal link 15 and the external link 17 about the yaw axis is variable.

It is noted that, in the legged robot 100, the external link 16 corresponds to the thorax 20, and the external link 17 corresponds to the waist 30. Specifically, with respect to the waist 30, the thorax 20 makes threefold free rotation: the free rotation by the second revolute joint 12 about the yaw axis, the free rotation by the first revolute joint 11 about the roll axis, and the free rotation by the third revolute joint 13 about the yaw axis. In other words, with respect to the thorax 20, the waist 30 makes threefold free rotation: the free rotation by the second revolute joint 12 about the yaw axis, the free rotation by the first revolute joint 11 about the roll axis, and the free rotation by the third revolute joint 13 about the yaw axis. Hence, the relative angles between the thorax 20 and the waist 30 about the above three axes are variable.

Here, each of the first revolute joint 11, the second revolute joint 12, and the third revolute joint 13 includes an actuator (driving unit) having a motor and a gear mechanism. Such actuators are independently driven by a control unit (control circuit) included in the head 40.

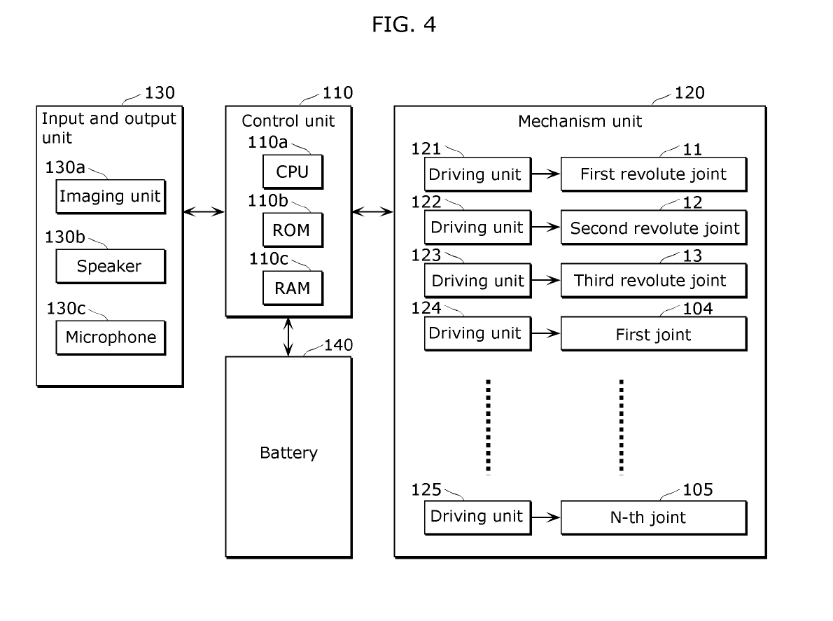

FIG. 4 depicts a block diagram showing a functional structure of the legged robot 100.

The legged robot 100 includes a control unit 110, a mechanism unit 120, an input and output unit 130, and a battery 140. The control unit 110 executes a predetermined control program, and the legged robot 100 according to the embodiment can perform autonomous actions. Moreover, the legged robot 100 includes input devices corresponding to five senses of a human and an animal, such as an image input unit (imaging unit 130a) and a sound input unit (microphone 130c), and has intelligence to perform a rational or emotional action in response to external inputs into the input units.

The control unit 110 is a computer system including a central processing unit (CPU) 110a, a read-only memory (ROM) 110b, and a random access memory (RAM) 110c.

The CPU 110a is, for example, a processor for executing a control program stored in the ROM 110b.

The ROM 110b holds programs such as the control program.

The RAM 110c reads and writes in a volatile storage area to be used as a work area for the CPU 110a to execute the control program. In addition, the RAM 110c temporarily holds, for example, image data obtained by the imaging unit 130a.

The control unit 110 controls the mechanism unit 120 and the input and output unit 130.

The mechanism unit 120 includes multiple joints for the legged robot 100, and multiple driving units each driving a corresponding one of the joints based on control given by the control unit 110. For example, a driving unit 121 drives the first revolute joint 11, a driving unit 122 drives the second revolute joint 12, and a driving unit 123 drives the third revolute joint 13. In the block diagram of FIG. 4, joints other than the first revolute joint 11, the second revolute joint 12, and the third revolute joint 13, such as the neck joint 41, a hip joint 53, and a knee joint 54 correspond to a first joint 104 to an n-th joint 105. The first joint 104 to the n-th joint 105 are driven by a driving unit 124 to a driving unit 125.

The imaging unit 130a is used for the legged robot 100 recognize a color and a shape of any given object. The imaging unit 130a is included in the head 40.

The speaker 130b is used for the legged robot 100 to produce a sound based on the control given by the control unit 110. For example, when the legged robot 100 recognizes a user in an image obtained by the imaging unit 130a, the legged robot 100 barks at the user through the speaker 130b. It is noted that the speaker 130b is included in the head 40.

The microphone 130c is used for the legged robot 100 to recognize sounds around the legged robot 100. The microphone 130c is included in the head 40.

The battery 140 is included in the waist 30 and can charge and discharge. The battery 140 supplies power to the control unit 110. An exemplary battery 140 is a lithium-ion rechargeable battery.

Described above is an exemplary functional structure of the legged robot 100. In other words, the functional structure of the legged robot 100 shall not be limited to the one shown in FIG. 4.

Described next is a mechanism of the legs 50.

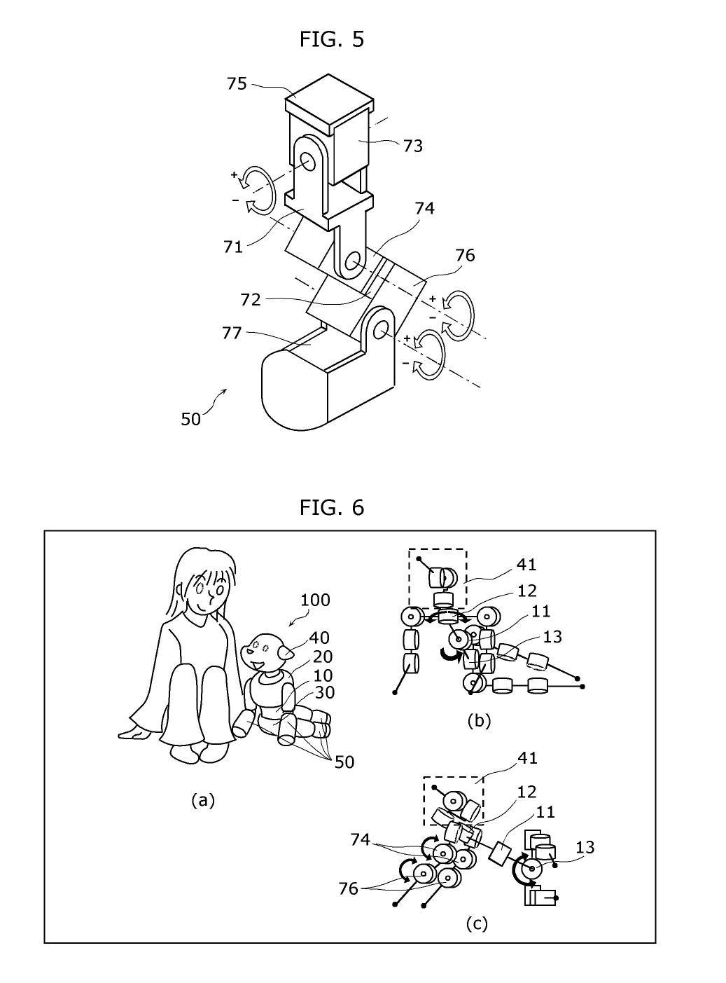

FIG. 5 depicts a perspective view showing an exemplary mechanism of the legs 50.

In FIG. 5, each of the legs 50 includes a revolute joint 73 which freely rotates about the roll axis, a revolute joint 74 which freely rotates about the pitch axis, and a revolute joint 76 which freely rotates about the pitch axis. The leg 50 includes a first leg link 75, a second leg link 71, a third leg link 72, and a fourth leg link 77. In FIG. 5, + (plus) and − (minus) with arrows respectively indicate the normal rotation direction and the reverse rotation direction.

As shown in FIG. 5, the first leg link 75 and the second leg link 71 are connected with each other via the revolute joint 73.

Moreover, the second leg link 71 and the third leg link 72 are connected with each other via the revolute joint 74. Specifically, one end of the second leg link 71, which is not connected to the revolute joint 73, is connected to the revolute joint 74.

Furthermore, the third leg link 72 and the fourth leg link 77 are connected with each other via the revolute joint 76. One end of the third leg link 72, which is not connected with the revolute joint 74, is connected with the revolute joint 76. One end of the revolute joint 76, which is not connected with the third leg link 72, is connected with the fourth leg link 77. Here, the revolute joint 76 rotates about the pitch axis.

The leg 50 including the above mechanism is connected to the trunk 10 (either the thorax 20 or the waist 30) of the legged robot 100. By moving (rotating) the revolute joints 74 and 76 together about the pitch axes, the legged robot 100 can bend and stretch the legs 50 as an animal does its legs. Moreover, by rotating the revolute joint 73 about the roll axis, the legged robot 100 can open and close the legs 50 as an animal does sits legs. Furthermore, by moving together all the revolute joints for the four legs 50, the legged robot 100 can walk as an animal does so on its four legs.

As described above, the legged robot 100 includes at least 18 revolute joints: three joints which form the neck joint 41 and each of which freely rotates about a corresponding one of the roll axis, the pitch axis, and the yaw axis; the first revolute joint 11, the second revolute joint 12, and the third revolute joint 13; and the revolute joints 73, 74, and 76 for each of the four legs 50. By driving an actuator of each revolute joint based on an instruction from the control unit 110, the legged robot 100 can exhibit complex motions.

Described hereinafter is how the legged robot 100 expresses emotional feelings, with reference to FIGS. 6 to 9.

The legged robot 100 according to an implementation of the present disclosure can exhibit the following motions: the motions of sitting with its legs out to one side and leaning on a person's leg to express emotional feelings of “sense of ease” and “dependence”; and the motion of lying on its back to express an emotional feeling of “obedience”. The legged robot 100 can also exhibit the following motions: the motion of rubbing its back on the floor to express an emotional feeling of “elevated mood”; and the motion of deeply bending itself as if chasing after its tail to express emotional feelings of “anxiety” and “stress”.

FIG. 6 shows how the legged robot 100 exhibits the motions of sitting with its legs out to one side and leaning on a person's leg to express emotional feelings of “sense of ease” and “dependence”. The illustration (a) in FIG. 6 is a front elevation view showing an external view of the legged robot 100 that sits with its legs out to one side. The illustration (b) in FIG. 6 is a perspective front elevation view showing an axis system in the legged robot 100 that sits with its legs out to one side. The illustration (c) in FIG. 6 is a perspective side view showing an axis system in the legged robot 100 that sits with its legs out to one side.

As shown in the illustration (a) in FIG. 6, when an animal, as typified by the dog, exhibits a motion of “sitting with its legs out to one side”, the animal first takes a posture of so called “sit”—that is standing its forelegs to the floor and bending its hind legs deeply to set down on the floor—, and then sits with its both hind legs out to one side. Not only taking the posture of sitting with its legs out to one side, the legged robot 100 can move its upper trunk having the sitting posture in vertical directions and in horizontal directions other than the frontal direction by stretching and bending its forelegs.

As shown in the illustration (b) in FIG. 6, the control unit 110 first rotates (drives) the first revolute joint 11 approximately 90 degrees to twist the thorax 20 and the waist 30 by 90 degrees from each other. Hence, two of the legs 50 which are connected to the waist 30 are moved sideways at the trunk 10 of the legged robot 100. Specifically, the control unit 110 causes the two legs 50 connected to the waist 30 to lie on the floor.

Moreover, when the two legs 50 are laid on the floor as shown in the illustration (b) in FIG. 6, the control unit 110 can change the orientation of the thorax 20 (the external link 16) by controlling the rotation amount of the second revolute joint 12.

Furthermore, as shown in the illustration (c) in FIG. 6, the control unit 110 can adjust how much the two legs 50 connected to the thorax 20 are to be bent and stretched, by controlling the rotation amounts of the revolute joints 74 and 76 that rotate about the pitch axes. In addition, the control unit 110 can adjust the height of the waist 30 (the external link 17) from the floor by controlling the rotation amount of the third revolute joint 13.

As described above, the legged robot 100 can freely change the inclination in the vertical direction of the upper trunk including the thorax 20 and take various postures of sitting with its legs out to one side. In other words, the legged robot 100 can express emotional feelings such as “sense of ease” and “dependence”.

Furthermore, the legged robot 100 can also express, through its posture, an interest degree showing how much the legged robot 100 is interested in an object.

As shown in the illustration (b) in FIG. 6, one of exemplary cases is where the legged robot 100 assumes a posture of gazing at an object such as a person and a thing when the legged robot 100 is “sitting with its legs out to one side”. In the case where the interest degree of the legged robot 100 to the object is low, the control unit 110 drives only the neck joint 41 and causes the head 40 to turn toward the object. In the case where the interest degree of the legged robot 100 to the object is high, the control unit 110 drives the second revolute joint 12 as well as the neck joint 41 so that the second revolute joint 12 is driven together with the neck joint 41. Hence, the control unit 110 causes the head 40 and the thorax 20 to turn toward the object. The above features contribute to more natural expressions of the interest degrees of the legged robot 100 to the object.

It is noted that the legged robot 100 recognizes an object based on, for example, an image obtained by the imaging unit 130a. For example, by checking the image obtained by the imaging unit 130a with a facial recognition capability for a digital camera, the control unit 110 can recognize the object as a person. Moreover, using the above control program, the control unit 110 may cause the legged robot 100 to take a posture showing a high interest degree when the control unit 110 recognizes a person, and to take a posture showing a low interest degree when the control unit 110 recognizes an object other than a person.

Described next is how legged robot 100 expresses an emotional feeling of “obedience”.

FIG. 7 shows how the legged robot 100 exhibits the motion of lying on its back to express the emotional feeling of “obedience”. The illustration (a) in FIG. 7 is a top view showing an external view of the legged robot 100 lying on the back. The illustration (b) in FIG. 7 is a perspective top view showing an axis system in the legged robot 100 taking the posture of lying on its side. The illustration (c) in FIG. 7 is a perspective top view showing an axis system in the legged robot 100 taking the posture of lying on the back.

An animal, as typified by the dog, first takes the posture of “sitting with its legs out to one side” in the illustration (a) in FIG. 6, followed by the posture of “lying on its side” so that the animal lies sideways on the floor. Then, the animal as typified by the dog takes advantage of one of or both (i) a reaction force generated when the animal presses the floor with its legs and (ii) a momentum generated when the animal twists its trunk axis, and changes its posture to “lying on the back” so that the back of the animal touches on the floor. The legged robot 100 can take such a posture of lying on the back.

When the legged robot 100 takes the posture of “sitting with its legs out to one side” as shown in the illustration (a) in FIG. 6, the control unit 110 leaves the two legs 50 connected to the waist 30 laid on the floor and turns the first revolute joint 11, which was turned approximately 90 degrees when the legged robot 100 was taking the posture of sitting with its legs out to one side, back to 0 degree as shown in the illustration (b) in FIG. 7. Hence, the control unit 110 lays the two legs 50 connected to the thorax 20 in the same direction as that of the two legs connected to the waist 30. Consequently, the legged robot 100 changes its posture to that of lying on its side, showing that the side of the trunk 10 of the legged robot 100 lies on the floor. Here, the side includes the right sides of the thorax 20 and the waist 30, and the right sides of two of the legs 50 corresponding to the right front leg and the right back leg of the legged robot 100.

Moreover, as shown in the illustration (c) in FIG. 7 when the legged robot 100 lies on its side, the control unit 110 drives two of the revolute joints 73 to rotate about the roll axes so that two of the legs 50 lying on the floor press the floor. Taking advantage of the reaction force generated by the above action, the legged robot 100 can take the posture of “lying on the back”, showing that the back, which is the top of the trunk 10 (the thorax 20 and the waist 30), lies on the floor. In other words, the legged robot 100 expresses an emotional feeling of “obedience”.

It is noted that, when the legged robot 100 changes its posture from lying on its side to lying on the back, the control unit 110 may use a momentum (inertial force) generated by a quick rotation of the first revolute joint 11 in the trunk 10 when the two legs 50, connected to the waist 30, are lying on the floor. In other word, the control unit 110 causes the first revolute joint 11 to swiftly rotate so that the two legs 50 connected to the waist 30 moves away from the floor and the top of the thorax 20 touches the floor. It is noted that, in order for the legged robot 100 to take the posture of “lying on the back”, the control unit 110 needs to cause the rotation of the first revolute joint 11 to reverse as soon as the top of the thorax 20 touches the floor, so that the top of the waist 30 also touches the floor. It is noted that the control unit 110 may cause the first revolute joint 11 to swiftly rotate, so that the two legs 50 connected to the thorax 20 moves away from the floor and the top of the waist 30 touches on the floor.

Described next is how the legged robot 100 expresses an emotional feeling of “elevated mood”.

FIG. 8 shows how the legged robot 100 exhibits the motion of rubbing its back on the floor to express the emotional feeling of “elevated mood”. The illustration (a) in FIG. 8 is a front elevation view showing an external view of the legged robot 100. The illustration (b) in FIG. 8 is a perspective front elevation view showing an axis system in the legged robot 100.

As shown in the illustration (a) in FIG. 8, an animal as typified by the dog exhibits the motion of “rubbing the back on the floor”; that is, the animal lies with its the back on the floor and largely and alternately moves the thorax and the waist in the horizontal direction without leaving the back from the floor. The legged robot 100 can exhibit such a motion of “rubbing the back on the floor”.

As shown in the illustration (b) in FIG. 8, when the legged robot 100 takes a posture of “lying on the back” as shown in the illustration (a) in FIG. 7, the control unit 110 drives the second revolute joint 12 to rotate in conjunction with the third revolute joint 13, so that the second revolute joint 12 provided to the thorax 20 rotates about the yaw axis and the third revolute joint 13 provided to the waist 30 rotates about the yaw axis. The control unit 110 drives the second revolute joint 12 to rotate in conjunction with the third revolute joint 13 so that, when seen from a direction perpendicular to the walking surface, the second revolute joint 12 and the third revolute joint 13 rotate in opposite directions and have the same rotation amount (rotation angle and rotation speed). Consequently, the control unit 110 causes the second revolute joint 12 and the third revolute joint 13 to alternately repeat a normal rotation and a reverse rotation. It is noted that, when seeing the legged robot 100 from the top perpendicular to the walking surface, the normal rotation direction of the second revolute joint 12 is the one that the thorax 20 (the external link 16) rotates counterclockwise with respect to the trunk 10 (the internal link 14 and the internal link 15) as shown in FIG. 3. In contrast, the normal rotation direction of the third revolute joint 13 is the one that the trunk 10 (the internal link 14 and the internal link 15) rotates counterclockwise with respect to the waist 30 (the external link 17).

Here, in appearance, the waist 30 repeats shifting in parallel and horizontal direction (sideways) with respect to the thorax 20. Hence, the legged robot 100 exhibits a motion of “rubbing its back” by greatly tilting the waist 30 sideways to express an emotional feeling of “elevated mood”.

Furthermore, when the second revolute joint 12 and the third revolute joint 13 cooperate with each other as described above and repeat the normal rotation and the reverse rotation, the waist 30 repeats the motion of greatly shifting with respect to the thorax 20. Hence, by deeply bending the trunk 10 and exhibiting the motion of “rubbing its back” in a big motion, the legged robot 100 can show in a more natural manner that its degree of “elevated mood” is high.

Described next is how the legged robot 100 expresses emotional feelings of “anxiety” and “stress”.

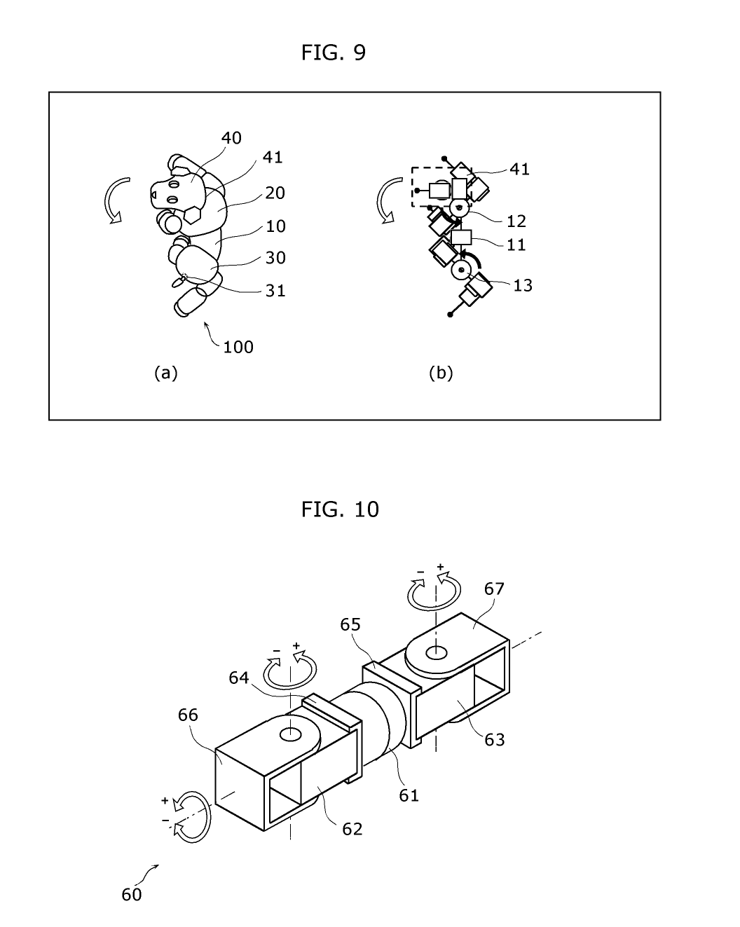

FIG. 9 shows how the legged robot 100 exhibits the motion of deeply bending itself as if chasing after its tail to express emotional feelings of “anxiety” and “stress”. The illustration (a) in FIG. 9 is a top view showing an external view of the legged robot 100. The illustration (b) in FIG. 9 is a perspective top view showing an axis system in the legged robot 100.

As shown in the illustration (a) in FIG. 9, when an animal as typified by the dog shows “chasing after its tail”, the animal exhibits a motion of walking with its side of the trunk deeply bent as if chasing after its tail, and walks the same place in a circle.

When the legged robot 100 takes the posture of “stand” in FIG. 1, the control unit 110 sends an instruction to the four legs 50 and causes the legs 50 to cooperate one another. Hence, the legged robot 100 performs an operation of “walk”. It is noted that the operation of “walk” is executed according to a walking pattern recorded on a predetermined control program. Here, the control unit 110 causes the trunk 10 to deeply bend by causing the second revolute joint 12 to rotate about the yaw axis near the thorax 20 and the third revolute joint 13 to rotate about the yaw axis near the waist 30. When seen from a direction perpendicular to the walking surface, the second revolute joint 12 and the third revolute joint 13 rotate in the same direction with the same rotation amount (the same rotation angle). Here, rotating in the same direction means that the internal link 15 and the external link 16 rotate in the same polarity; that is, either + (plus) or − (minus) shown in FIG. 3.

Moreover, the control unit 110 additionally rotates the neck joint 41 so that the head 40 moves closer to the tail 31, and causes the legged robot 100 to walk with the head 40 and the tail 31 brought close to each other. Hence, the legged robot 100 can express emotional feelings of “anxiety” and “stress” by exhibiting a motion of “chasing after its tail”.

As described above, the legged robot 100 according to an implementation of the present disclosure can show typical exhibitions of motions associated with expressions of a dog's emotional feelings, even though built in a simple structure. Specifically, the legged robot 100 can exhibit motions of: sitting with its legs out to one side and leaning on a person's leg and a wall, lying on the back, rubbing its back on the floor, and walking with its trunk deeply bent as if chasing after its tail.

It is noted that, in the embodiment, the first revolute joint 11, the second revolute joint 12, and the third revolute joint 13, are each described as a separate member. In the present disclosure, a joint means a junction between links. In other words, the joint in the present disclosure does not have to be provided as a single member in FIG. 3.

Furthermore, the joint mechanism of the trunk 10 shall not be defined as the one in FIG. 3.

In the joint mechanism shown in FIG. 3, suppose the case where the second revolute joint is the junction between a link 12 (third link) and the internal link 14 (first link). Here, the driving unit for driving the second revolute joint is to be provided to the link 12. The driving unit for driving the second revolute joint, however, may be provided to the internal link 14. Similarly, in the joint mechanism shown in FIG. 3, suppose the case where the third revolute joint is the junction between a link 13 (fourth link) and the internal link 15 (second link). Here, the driving unit for driving the third revolute joint is to be provided to the link 13. The driving unit for driving the third revolute joint, however, may be provided to the internal link 15.

FIG. 10 depicts a perspective view showing another exemplary joint mechanism of the trunk 10.

In the example shown in FIG. 10, a trunk 60 includes a first revolute joint 61 which freely rotates about the roll axis, a second revolute joint 62 which freely rotates about the yaw axis, and a third revolute joint 63 which freely rotates about the yaw axis. In FIG. 10, + (plus) and − (minus) with arrows respectively indicate the normal rotation direction and the reverse rotation direction.

FIG. 10 shows that, to an end of the first revolute joint 61, an internal link 64 having the second revolute joint 62 is connected. To the other end of the first revolute joint 61, an internal link 65 having the third revolute joint 63 is connected. Hence, the relative angle between the internal link 64 and the external link 65 about the yaw axis is variable.

It is noted that the second revolute joint 62 includes a driving unit for driving the second revolute joint 62.

Meanwhile, one end of the second revolute joint 62, which is not connected with the internal link 64 that is connected to the other end of the second revolute joint 62, is connected with an external link 66. Hence, the relative angle between the internal link 64 and the external link 66 about the yaw axis is variable.

It is noted that the third revolute joint 63 includes a driving unit for driving the third revolute joint 63.

Meanwhile, one end of the third revolute joint 63, which is not connected with the internal link 65 that is connected to the other end of the third revolute joint 63, is connected with an external link 67. Hence, the relative angle between the internal link 65 and the external link 67 about the yaw axis is variable.

Then, the thorax 20 is attached to the external link 66 and the waist 30 is attached to the external link 67. Hence, with respect to the waist 30, the thorax 20 can change the relative angle with threefold free rotation: the rotation of the second revolute joint 62 about the yaw axis, the rotation of the first revolute joint 61 about the roll axis, and the rotation of the third revolute joint 63 about the roll axis.

It is noted that, in FIG. 10, a link does not necessarily mean a member. In FIG. 10, suppose the case where the internal link 64 is not provided, and the first revolute joint 61 and the second revolute joint 62 are directly joined with each other. Here, the link is the junction between the first revolute joint 61 and the second revolute joint 62.

As described above, in the joint mechanism shown in FIG. 10, suppose the case where the second revolute joint is the junction between a link 62 (first link) and the external link 66 (third link). Here, the driving unit for driving the second revolute joint is to be provided to the link 62. Similarly, in the joint mechanism shown in FIG. 10, suppose the case where the third revolute joint is the junction between a link 63 (second link) and the external link 67 (fourth link). Here, the driving unit for driving the third revolute joint is to be provided to the link 63.

As a matter of course, the joint mechanism shown in FIG. 10 makes it possible to execute the motions and express the emotional feelings similar to those described in the embodiment.

Built in a simple structure, the legged robot according to an implementation of the present disclosure can show typical exhibitions of motions associated with expressions of a dog's emotional feelings, such as the motions of sitting with its legs out to one side and leaning on a person's leg and a wall, lying on the back, rubbing its back on the floor, and walking with its trunk deeply bent as if chasing after its tail.

It is noted that the embodiment describes a legged robot having four legs attached to external links provided to both ends of the joint mechanism of the trunk 10. This structure is also applicable to a robot with two legs provided at least one of the external links. In other words, the embodiment is applicable to a humanoid robot with two legs. As a matter of course, the legged robot according to an implementation of the present disclosure may be applied to a human baby robot which crawls on all fours. In such a case, the thorax and the waist may be provided according to the form of the legged robot.

Although only an exemplary embodiment of the present disclosure has been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure can implement a legged robot which is built in a simple structure and shows highly expressive emotions, and the legged robot according to an implementation of the present disclosure is effective as an animal-type communication robot.

1. A legged robot comprising:
a trunk; and
a leg connected to the trunk,
wherein the trunk includes:
a first link and a second link which are connected with each other via a first revolute joint that is rotatable about a roll axis;
a third link which is connected with the first link via a second revolute joint that is rotatable about a yaw axis; and
a fourth link which is connected with the second link via a third revolute joint that is rotatable about a yaw axis, and
the leg is connected to at least one of the third link and the fourth link.

2. The legged robot according to claim 1,
wherein the first link and the second link do not include therein any movable parts.

3. The legged robot according to claim 1, further comprising:
a left front leg and a right front leg which are included in the leg that is connected to the third link; and
a left back leg and a right back leg which are included in the leg that is connected to the fourth link,
wherein the legged robot walks on a walking surface using the left front leg, the right front leg, the left back leg, and the right back leg.

4. The legged robot according to claim 3, further comprising
a control unit configured to control driving of the first revolute joint, the second revolute joint, and the third revolute joint to drive.

5. The legged robot according to claim 4,
wherein when the legged robot is standing on the walking surface,
the control unit is configured to
cause the legged robot to sit with the left back leg and the right back leg out to one side, by driving the first revolute joint to move the second link with respect to the first link, and laying the left back leg and the right back leg on the walking surface,
when the legged robot is sitting with the left back leg and the right back leg out to one side, an orientation of the third link about the yaw axis is variable through the drive of the second revolute joint, and
a distance between the walking surface and the fourth link is variable through the drive of the third revolute joint.

6. The legged robot according to claim 4,
wherein when the legged robot is laying the left back leg and the right back leg on the walking surface, and sitting with the left back leg and the right back leg out to one side,
the control unit is configured to
cause the legged robot to lie on one side the trunk laid on the walking surface, by (i) driving the first revolute joint to move the first link with respect to the second link, and (ii) laying the left front leg and the right front leg in a same direction in which the left back leg and the right back leg are laid.

7. The legged robot according to claim 4,
wherein when the legged robot is lying on one side with the trunk laid on the walking surface,
the control unit is configured to
cause the legged robot to lie back and show that a top of the trunk, seen when the legged robot stands on the walking surface, touches on the walking surface by one of:
(i) an inertial force generated by driving the first revolute joint to move the laid left front leg and the laid right front leg away from the walking surface; and
(ii) an inertial force generated by driving the first revolute joint to move the laid left back leg and the laid right back leg away from the walking surface.

8. The legged robot according to claim 4,
wherein when the legged robot is lying back and showing that a top of the trunk, seen when the legged robot stands on the walking surface, touches the walking surface, and
when, seen from a direction perpendicular to the walking surface, a normal direction is (i) a rotation direction of the second revolute joint in which the third link rotates clockwise with respect to the first link, and (ii) a rotation direction of the third revolute joint in which the second link rotates clockwise with respect to the fourth link,
the control unit is configured to:
drive the second revolute joint to alternately rotate in the normal direction and a direction which is opposite the normal direction; and
drive the third revolute joint to rotate in conjunction with the second revolute joint, so that the second revolute joint and the third revolute joint rotate at a same rotation speed in opposite directions.

9. The legged robot according to claim 4,
wherein when the legged robot stands on the walking surface, and
when, seen from a direction perpendicular to the walking surface, a normal direction is (i) a rotation direction of the second revolute joint in which the third link rotates clockwise with respect to the first link, and (ii) a rotation direction of the third revolute joint in which the second link rotates clockwise with respect to the fourth link,
the control unit is configured to
cause the legged robot to walk with both the second revolute joint and the third revolute joint driven in one of the normal direction and a direction which is opposite the normal direction.

10. The legged robot according to claim 4,
wherein the control unit is configured to cause driving units to drive the first revolute joint, the second revolute joint, and the third revolute joint, the driving units each being provided to a corresponding one of the first revolute joint, the second revolute joint, and the third revolute joint,
one of the driving units for driving the second revolute joint is provided to the third link, and
one of the driving units for driving the third revolute joint is provided to the fourth link.

11. The legged robot according to claim 4,
wherein the control unit is configured to cause driving units to drive the first revolute joint, the second revolute joint, and the third revolute joint, the driving units each being provided to a corresponding one of the first revolute joint, the second revolute joint, and the third revolute joint,
one of the driving units for driving the second revolute joint is provided to the first link, and
one of the driving units for driving the third revolute joint is provided to the second link.
